(19) United States
(12) Patent Application Publication
(10) Pub. No.: US 2023/0392751 A1
(43) Pub. Date: Dec. 7, 2023

(54) SEALED AND THERMALLY INSULATING TANK

(71) Applicant: GAZTRANSPORT ET TECHNIGAZ, SAINT REMY LES CHEVREUSE (FR)

(72) Inventors: Bruno DELETRE, SAINT REMY LES CHEVREUSE (FR); Alain TESSIER, SAINT REMY LES CHEVREUSE (FR)

(21) Appl. No.: 18/034,127

(22) PCT Filed: Oct. 27, 2021
(86) PCT No.: PCT/EP2021/079883

§ 371 Date: Apr. 27, 2023

(30) Foreign Application Priority Data
Oct. 29, 2020 (FR) FR2011105

(51) Int. Cl. F17C 3/02; B63B 25/16; B63B 27/34

(52) U.S. Cl. CPC F17C 3/027; B63B 25/16; B63B 27/34; F17C 2203/0358; F17C 2221/033; F17C 2223/0161; F17C 2260/033; F17C 2270/0107

(57) ABSTRACT

A sealed and thermally insulating tank has a thermally insulating barrier and a sealing membrane. The tank has a channel extending in a longitudinal direction along the sealing membrane. The thermally insulating barrier forms a bottom of the channel. The tank further has a closure member that is a flexible film. The flexible film has a first fastening zone extending transversely to the longitudinal direction of the channel and fastened to the bottom of the channel and a second fastening zone extending transversely to the longitudinal direction of the channel and fastened to the sealing membrane. The flexible film has a closure portion interposed between the first fastening zone and the second fastening zone. The closure portion closes the channel in order to create a loss of pressure in the channel.

### TECHNICAL FIELD

The invention relates to the field of sealed and thermally insulating tanks, with membranes, for storing and/or transporting fluid, such as a cryogenic fluid.

Sealed and thermally insulating tanks with membranes are notably employed for storing liquefied natural gas (LNG), which is stored, at atmospheric pressure, at approximately −162° C. These tanks can be installed onshore or on a floating structure. In the case of a floating structure, the tank can be intended to transport liquefied natural gas or to receive liquefied natural gas serving as fuel for the propulsion of the floating structure.

### TECHNOLOGICAL BACKGROUND

In the state of the art, sealed and thermally insulating tanks are known for storing liquefied natural gas, incorporated in a bearing structure, such as the double-hull of a ship intended to transport liquefied natural gas. Generally, such tanks comprise a multilayer structure having, in succession, in the thickness-wise direction, from the outside to the inside of the tank, a secondary thermal insulation barrier retained on the bearing structure, a secondary sealing membrane resting against the secondary thermal insulation barrier, a primary thermal insulation barrier resting against the secondary sealing membrane and a primary sealing membrane resting against the primary thermal insulation barrier and intended to be in contact with the liquefied natural gas contained in the tank.

The document WO2016/046487 describes a secondary thermal insulation barrier and a primary thermal insulation barrier formed by juxtaposed insulating panels. In this document WO2016/046487, the secondary sealing membrane is composed of a plurality of metal sheets comprising corrugations protruding toward the outside of the tank and thus allowing the secondary sealing membrane to be deformed under the effect of the thermal and mechanical strains generated by the fluid stored in the tank. An inner face of the insulating panels of the secondary thermal insulation barrier has grooves receiving the corrugations of the corrugated metal sheets of the secondary sealed membrane. These corrugations and these grooves form a meshing of channels running along the walls of the tank.

The document WO2014167214 A2 describes a corner structure of a multilayer sealed and thermally insulating tank in which the secondary thermally insulating barrier at a corner between two walls of the tank comprises two insulating panels forming an edge, the secondary sealed membrane comprising, in line with said edge, a flexible sealed film linking secondary sealed membrane portions of said two tank walls.

A central portion of this flexible sealed film, that is to say interposed between the portions of said flexible sealed film anchored to the secondary sealed membrane portions of the two tank walls, is not anchored to the secondary thermally insulating barrier and is therefore free with respect to said secondary thermally insulating barrier.

Thus, when the sealed and thermally insulating tank is cooled, the thermal contraction of the insulating panels forming the edge and of the sealed membrane is absorbed by a deformation of the central portion of the flexible sealed film, typically said flexible sealed film is able to tighten to absorb the strains linked to this contraction. However, when the flexible film tightens, a space appears or becomes larger between said central portion of the flexible sealed film and the thermally insulating barrier. This space runs over the entire length of the edge.

Such a space forms a channel promoting convection and is therefore likely to degrade the thermal insulation efficiencies of the tank, in particular in the context of edges having a component that is parallel to the direction of the Earth's gravity.

### SUMMARY

One idea on which the invention is based is to propose a sealed and thermally insulating tank in which the convection phenomena are reduced. In particular, one idea on which the invention is based is to provide a sealed and thermally insulating tank that limits the presence of continuous circulation channels in the thermally insulating barriers, and more particularly between the thermally insulating barriers and the sealed membranes, in order to limit the phenomena of natural convection in said thermally insulating barriers.

According to one embodiment, the invention provides a sealed and thermally insulating tank for storing fluid, said tank comprising a thermally insulating barrier and a sealed membrane, the tank comprising a channel running along a longitudinal direction, said channel extending along the sealed membrane and being delimited on the one hand by the thermally insulating barrier and, on the other hand, by an outer face of the sealed membrane, the thermally insulating barrier forming a bottom of the channel, the tank further comprising a shutter arranged in the channel, said shutter comprising a flexible film, said flexible film comprising a first fixing zone and a second fixing zone, the first fixing zone extending transversely to the longitudinal direction of the channel, the first fixing zone of said flexible film being fixed to the bottom of the channel, the second fixing zone extending transversely to the longitudinal direction of the channel, the second fixing zone being fixed to the outer face of the sealed membrane delimiting the channel, the flexible film comprising a shutting portion extending from the first fixing zone to the second fixing zone, said shutting portion extending across the channel between the bottom of the channel and the sealed membrane so as to create a head loss in the channel.

The expression “fixing zone extending transversely to the longitudinal direction of the channel” is understood to mean a zone of the flexible film extending in a secant fashion, preferably at right angles, to the longitudinal direction of the channel.

By virtue of these features, the convection phenomena in the tank, and in particular in the channel, are reduced. Indeed, the shutter makes it possible to generate a head loss in a stream flow that may occur in the channel while allowing the circulation of gas, for example of inert gas.

Indeed, since the fixing zone of the flexible film is fixed to the bottom of the channel in a direction transverse to the longitudinal direction of the channel and the second fixing zone is fixed to the outer face of the sealed membrane in a direction transverse to the longitudinal direction of the channel, the shutting portion runs between the bottom of the channel and the outer face of the sealed membrane thus allowing a good shutting of the channel. Furthermore, since the second fixing zone is fixed to the sealed membrane, said second fixing zone follows the deformations of the sealed membrane such that this shutting portion is present even when the sealed membrane deforms. Furthermore, this fixing of the first and second fixing zones makes it possible to dispense, in a simple manner, with the manufacturing and/or positioning tolerances of the thermally insulating barrier and/or of the sealed membrane while retaining a good shutting of the channel.

According to embodiments, such a sealed and thermally insulating tank can comprise one or more of the following features.

According to one embodiment, the first fixing zone and the second fixing zone are offset in the longitudinal direction of the channel. In other words, the first fixing zone and the second fixing zone are not contiguous such that the shutting portion runs with a component parallel to the longitudinal direction of the channel.

According to one embodiment, the shutting portion is movable with respect to the bottom of the channel. According to one embodiment, the shutting portion is movable with respect to the sealed membrane. In other words, according to one embodiment, the shutting portion is free with respect to the bottom of the channel and the sealed membrane. Thus, the shutting portion shuts the channel in a non-sealed manner and therefore allows the circulation of inert gas in the channel while creating the head loss in the flow.

According to one embodiment, the shutting portion is deformable between the bottom of the channel and the sealed membrane. This deformability of the shutting portion can be obtained in many ways. According to one embodiment, the flexible film is produced in an elastically deformable material. According to one embodiment, the shutting portion has a length, when said shutting portion is arranged in a plane, greater than the distance between a surface for fixing the first fixing zone to the bottom of the channel and a surface for fixing the second fixing zone to the sealed membrane. In other words, according to one embodiment, the shutting portion is in a loose state in the channel, in particular at ambient temperature.

According to one embodiment, the shutting portion situated between the bottom of the channel and the sealed membrane is deformable and comprises at least one fold along an axis transverse to the longitudinal direction of the channel.

According to one embodiment, the first fixing zone and the second fixing zone are situated at two opposite ends of the flexible film and are disposed at a same level in the longitudinal direction of the channel.

The shutter then has, for example, a U-shaped form that is particularly advantageous and suited to an in-situ installation in the tank. Such a shutter can be installed with a tool, for example a blade allowing the shutter to be inserted into the channel without damaging it.

According to one embodiment, the shutter comprises a compressible element which is prestressed and housed in the fold between the first and second fixing zones so as to exert a reaction force pressing the first fixing zone against the bottom of the channel and the second fixing zone against the outer face of the sealed membrane delimiting the channel.

According to one embodiment, the compressible element is produced in a material chosen from among cotton, felt, glass wool, rock wool, polymer foams, polyethylene cotton or the like and extending in the thickness-wise direction between the first fixing zone and the second fixing zone. By virtue of this feature, the fixing by gluing is facilitated.

According to one embodiment, an anti-adhesive film is inserted into the fold to avoid gluing together the two flats of the flexible film folded onto one another, for example under the effect of any overflows of adhesives. The anti-adhesive film can be a sheet of polyethylene or of PTFE. According to one embodiment, the anti-adhesive film inserted into the fold comprises an end situated in the fold and a second end situated outside of the fold. This feature makes it possible to facilitate the installation of the shutter in the tank and avoid any overflows of adhesives from disrupting the installation of the shutter. The anti-adhesive film can be inserted alone or in combination with a compressible element. To facilitate the installation of the shutter in the tank, the anti-adhesive film and the flexible film can be folded successively around the end edge of the blade in order to push them into the channel.

According to one embodiment, the shutting portion comprises two folds mutually spaced apart in the longitudinal direction of the channel, each fold being produced along an axis transverse to the longitudinal direction of the channel, the first fixing zone and the second fixing zone being situated at two opposite ends of the flexible film and offset in the longitudinal direction of the channel. The shutter has, for example, a Z-shaped form.

According to one embodiment, the shutter has a direction of elongation extending between the first fixing zone and the second fixing zone, the flexible film being produced in a woven fabric material and comprising threads oriented between 35° and 55° (degrees) with respect to the direction of elongation; preferentially, the threads are oriented at 45° with respect to the direction of elongation. By virtue of this feature, the shutter obtains a flexibility through the deformation of the weft threads and of the warp threads of the woven fabric.

By virtue of these features, the shutting portion makes it possible to follow the variations of relative positioning and of dimensioning of the thermally insulating barrier and/or of the sealed membrane while shutting the channel effectively in order to create the head loss in a flow within said channel. In particular, such a shutter allows this effective shutting of the channel including when the tank is cooled, that is to say in the case of thermal contraction of the sealed membrane and of the thermally insulating barrier and therefore of variation of the deviation between the first fixing zone and the second fixing zone.

According to one embodiment, the shutting portion of the flexible film is a first shutting portion, the flexible film comprises a third fixing zone extending transversely to the longitudinal direction of the channel, the third fixing zone being fixed to the bottom of the channel, the second fixing zone being interposed between the first fixing zone and the third fixing zone, the flexible film comprising a second shutting portion extending from the second fixing zone to the third fixing zone, said second shutting portion extending across the channel between the bottom of the channel and the sealed membrane so as to create a head loss in the channel.

Such a shutter allows a good shutting of the channel and therefore a significant head loss in the flow of the stream.

According to one embodiment, the third fixing zone is offset along the longitudinal direction of the channel with respect to the first fixing zone and to the second fixing zone.

According to one embodiment, the second shutting portion is movable with respect to the bottom of the channel.

According to one embodiment, the second shutting portion is movable with respect to the sealed membrane.

In other words, according to one embodiment, the second shutting portion is free with respect to the bottom of the channel and to the sealed membrane. Thus, the second shutting portion shuts the channel in a non-sealed manner and therefore allows the circulation of inert gas in the channel while creating the head loss in the flow.

According to one embodiment, the second shutting portion is deformable between the bottom of the channel and the sealed membrane. This deformability of the second shutting portion can be obtained in many ways, for example in a way similar to the examples above for the first shutting portion.

According to one embodiment, the flexible film is made of material chosen from the group consisting of a glass mat, a polyethylene film and/or a polyamide film. As an example, the film can be: a glass-based fabric, a polyethylene fabric, a polyamide fabric, a polyimide fabric, a polyetherimide fabric, this list being non-exhaustive. Such materials exhibit a good resistance to cold while retaining flexibility allowing the flexible film to follow the deformations of the sealed membrane.

According to one embodiment, the first fixing zone runs in a plane secant to the longitudinal direction of the channel.

According to one embodiment, the first fixing zone runs in a plane at right angles to the longitudinal direction of the channel.

According to one embodiment, the second fixing zone runs in a plane secant to the longitudinal direction of the channel.

According to one embodiment, the second fixing zone runs in a plane at right angles to the longitudinal direction of the channel.

Such anchoring zones arranged at right angles to the longitudinal direction of the channel allow a good shutting of the channel by the shutting portion or portions.

According to one embodiment, the first fixing zone and/or the second fixing zone is fixed by gluing. According to one embodiment, the tank comprises a double-sided adhesive strip interposed between the first fixing portion and the bottom of the channel in order to fix said first fixing portion to the bottom of the channel. According to one embodiment, the tank comprises a double-sided adhesive strip interposed between the sealed membrane and the second fixing zone in order to fix said second fixing zone to the sealed membrane. Such adhesive strips make it possible to fix the first and second fixing zones simply and rapidly. Furthermore, such adhesive strips allow the flexible film to be fixed simply by simple application or pressure of the flexible film on said adhesive strips or vice versa.

According to one embodiment, the tank comprises a plurality of shutters arranged in the channel along the longitudinal direction of the channel. Thus, a stream flow in the channel is controlled along the channel. Such shutters can comprise one or several, or be all such as the shutters described above.

According to one embodiment, the shutters of the plurality of shutters are arranged in the channel at regular intervals.

According to one embodiment, the thermally insulating barrier forming the bottom of the channel comprises a plurality of insulating panels spaced apart, for example regularly or irregularly, and a plurality of junction zones situated between the insulating panels, for example with a regular or irregular pitch between two junction zones. The shutters can be arranged facing insulating panels in such a way that the junction zones at each end of a panel are located between the shutters. For example, the shutters are mutually spaced apart by an interval corresponding to the regular or irregular pitch of the junction zones. In one embodiment, at least one shutter is disposed facing each insulating panel. Thus, there is always at least one shutter which blocks the flow between two successive junction zones.

According to one embodiment, the shutters are arranged at irregular intervals.

According to one embodiment, the sealed and thermally insulating tank comprises a first tank wall and a second tank wall, the first tank wall and the second tank wall forming an edge of the thermally insulating barrier, the first tank wall comprising a first anchoring surface and the second tank wall forming a second anchoring surface, the bottom of the channel being formed by the thermally insulating barrier between the first anchoring surface and the second anchoring surface, the bottom of the channel forming the edge, and the sealed membrane comprises a corner sealed part, the corner sealed part comprising a first portion anchored to the first anchoring surface and a second portion anchored to the second anchoring surface, the corner sealed part further comprising a central portion interposed between the first portion and the second portion, said central portion being free with respect to the thermally insulating barrier so as to absorb by deformation the strains in the sealed membrane in line with the edge, the channel being delimited by the outer face of the corner sealed part.

According to one embodiment, the sealed and thermally insulating tank comprises a corner structure, said corner structure comprising a first insulating panel and a second insulating panel, the first insulating panel forming an end of the thermally insulating barrier of the first tank wall, the second insulating panel forming an end of the thermally insulating barrier of the second tank wall, the first insulating panel and the second insulating panel jointly forming the edge, the corner structure further comprising a first sealed membrane portion and a second sealed membrane portion, the first sealed membrane portion resting on the first insulating panel, said first sealed membrane portion forming an end of the sealed membrane of the first tank wall, the second sealed membrane portion resting on the second insulating panel, said second sealed membrane portion forming an end of the sealed membrane of the second tank wall.

According to one embodiment, the first sealed membrane portion comprises a first composite film fixed to the first insulating panel and the second sealed membrane portion comprises a second composite film fixed to the second insulating panel.

According to one embodiment, the first sealed membrane portion comprises a laminated composite sealed film comprising a metallic sheet interposed between two resin-impregnated fiber layers. According to one embodiment, the first sealed membrane portion is glued to the first insulating panel. According to one embodiment, the second sealed membrane portion comprises a laminated composite sealed film comprising a metallic sheet interposed between two resin-impregnated fiber layers. According to one embodiment, the second sealed membrane portion is glued to the second insulating panel.

According to one embodiment, the first sealed membrane portion is a metallic plate anchored to the first thermally insulating barrier portion. According to one embodiment, the second sealed membrane portion is a metallic plate anchored to the second thermally insulating barrier portion.

According to one embodiment, the first insulating panel forms the first anchoring surface. According to one embodiment, the second insulating panel forms the second anchoring surface.

According to one embodiment, the first sealed membrane portion, for example an edge of said first sealed membrane portion, forms the first anchoring surface. According to one embodiment, the second sealed membrane portion, for example an edge of said second sealed membrane portion, forms the second anchoring surface.

The corner sealed part can be fixed in many ways to the first and second anchoring surfaces. According to one embodiment, the corner sealed part is glued to one or both of the first and second anchoring surfaces. According to one embodiment, the corner sealed part is welded to one or both of the first and second anchoring surfaces.

According to one embodiment, the corner sealed part comprises a composite flexible sealed film, for example a laminated composite comprising a metallic sheet interposed between two glass fiber layers.

According to one embodiment, the corner sealed part is a metal angle iron.

By virtue of these features, the corner of a sealed and thermally insulating tank can be manufactured simply and rapidly without the risk of generating any convection phenomenon. In particular, these features allow the use of a metal angle iron or of a sealed flexible film to produce the sealed membrane in the corner of the tank while ensuring the absence of convection between the sealed membrane and the thermally insulating barrier in said corner of the tank.

According to one embodiment, the sealed and thermally insulating tank further comprises a filler block, said filler block comprising a first outer face resting against the thermally insulating barrier of the first tank wall and a second outer face resting against the thermally insulating barrier of the second tank wall, the filler block further comprising a concave inner face, the channel being delimited by the inner face of the filler block.

According to one embodiment, one end, preferably two opposite ends, of the first fixing zone and/or of the second fixing zone overlaps the channel so as to be interposed between the sealed membrane and the thermally insulating barrier. Thus, the fixing of the first fixing zone and/or of the second fixing zone is simple and reliable, said end being pinched between the sealed membrane and the thermally insulating barrier.

According to one embodiment, one end, preferably two opposite ends, of the first fixing zone and/or of the second fixing zone overlaps the channel so as to be interposed between two contiguous portions of the sealed membrane, said two contiguous portions being linked in a seal-tight manner. Thus, the fixing of the first fixing zone and/or of the second fixing zone is simple and reliable, said end being pinched between said two contiguous portions of the sealed membrane.

According to one embodiment, the sealed membrane comprises a corrugation, said corrugation protruding toward the thermally insulating barrier, said corrugation running in the longitudinal direction of the channel, the thermally insulating barrier comprising a groove, said corrugation being housed in said groove, the bottom of the channel being formed by said groove.

According to one embodiment, the sealed membrane comprises a series of parallel corrugations and flat portions, said flat portions being situated between two adjacent parallel corrugations, said parallel corrugations protruding toward the thermally insulating barrier,
the thermally insulating barrier comprising a series of parallel grooves, the parallel corrugations being housed in one said respective groove,
the tank further comprising a plurality of channels delimited on the one hand by one said respective groove and, on the other hand, by the sealed membrane, a bottom of each channel being formed by one said corresponding groove,
the tank further comprising a plurality of shutters, said shutters comprising a flexible film, said flexible film comprising a first fixing zone and a second fixing zone,
the first fixing zone extending transversely to the longitudinal direction of the corresponding groove, the first fixing zone of said flexible film being fixed to the bottom of the corresponding channel,
the second fixing zone extending transversely to the longitudinal direction of said channel,
the second fixing zone being fixed to the outer face of the sealed membrane delimiting said channel,
said flexible film comprising a shutting portion extending from the first fixing zone to the second fixing zone, said shutting portion extending across the channel between the bottom of said channel and the sealed membrane so as to create a head loss in said channel.

By virtue of these features, it is possible to house the corrugations of a corrugated sealed membrane in grooves of the thermally insulating barrier without that generating natural convection phenomena that are damaging to the insulation properties of the thermally insulating barrier.

According to one embodiment, the channel has a component parallel to the direction of the Earth's gravity.

According to one embodiment, the channel is parallel to the direction of the Earth's gravity.

Such channels having a vertical component are the most likely to promote convection phenomena such that the arrangement of the shutter or shutters in one such channel is particularly advantageous and effectively reduces the convection phenomena.

According to one embodiment, the channel has a component at right angles to the direction of the Earth's gravity.

According to one embodiment, the channel is at right angles to the direction of the Earth's gravity.

Such a tank can form part of an onshore storage installation, for example for storing LNG, or be installed in a floating, coastal or deep water structure, notably a methane tanker ship, a floating storage and regasification unit (FSRU), a floating production and storage offshore unit (FPSO) and the like. Such a tank can also serve as fuel tank in any type of ship.

According to one embodiment, the invention also provides a ship for transporting a cold liquid product comprises a double-hull and an abovementioned tank disposed in the double-hull.

According to one embodiment, the invention also provides a method for loading or offloading such a ship, in which a cold liquid product is conveyed through insulated pipelines from or to a floating or onshore storage installation to or from the tank of the ship.

According to one embodiment, the invention also provides a transfer system for a cold liquid product, the system comprising the abovementioned ship, insulated pipelines arranged so as to link the tank installed in the hull of the ship to a floating or onshore storage installation and a pump for driving a flow of cold liquid product through the insulated pipelines from or to the floating or onshore storage installation to or from the tank of the ship.

### BRIEF DESCRIPTION OF THE FIGURES

The invention will be better understood, and other aims, details, features and advantages thereof will become more clearly apparent from the following description of several particular embodiments of the invention, given purely in an illustrative and nonlimiting manner, with reference to the attached drawings.

FIG. 1 is a schematic perspective view of a cross section of a portion of sealed and thermally insulating tank arranged in a bearing structure;

FIG. 2 is a schematic perspective view of a corner structure of the tank illustrated in [FIG. 1];

FIG. 3 is a detail view of an edge of the secondary thermally insulating barrier belonging to the corner structure of [FIG. 2];

FIG. 4 is a schematic representation illustrating the secondary sealed membrane and the secondary thermally insulating barrier at the corner of the sealed and thermally insulating tank in a tank at ambient temperature;

FIG. 5 is a schematic representation illustrating the secondary sealed membrane and the secondary thermally insulating barrier at the corner of the sealed and thermally insulating tank in a tank comprising a cryogenic liquid;

FIG. 6 is a schematic representation illustrating a shutter fixed to the secondary thermally insulating barrier at the edge formed by said secondary thermally insulating barrier in a tank comprising a cryogenic liquid;

FIG. 7 is a schematic representation illustrating the secondary sealed membrane and the secondary thermally insulating barrier at the corner of the sealed and thermally insulating tank according to a variant embodiment of [FIGS. 4 and 5];

FIG. 8 is a schematic perspective view of a portion of thermally insulating barrier on which rests a corrugated sealed membrane with outgoing corrugations, said corrugated sealed membrane being illustrated by transparency, a shutter being arranged between the corrugated sealed membrane and the thermally insulating barrier;

FIG. 9 is a perspective schematic view illustrating the corner of the sealed and thermally insulating tank provided with a shutter with head loss according to yet another embodiment;

FIG. 10 is a lateral view of the shutter with head loss according to the arrow XIII of [FIG. 9];

FIG. 11 is a view similar to [FIG. 10] of a shutter with head loss according to another embodiment;

FIG. 12 is a cutaway schematic representation of a tank of a methane tanker ship comprising a sealed and thermally insulating tank and of a terminal for loading/offloading this tank.

### DESCRIPTION OF THE EMBODIMENTS

By convention, the terms “outer” and “inner” are used to define the relative position of one element relative to another, with reference to the inside and the outside of the tank.

A sealed and thermally insulating tank for storing and transporting a cryogenic fluid, for example liquefied natural gas (LNG), comprises a plurality of tank walls each having a multilayer structure.

Such tank walls comprise, from the outside to the inside of the tank, a secondary thermally insulating barrier 1 anchored to a bearing structure 2 by secondary retaining members (not illustrated), a secondary sealed membrane 3 borne by the secondary thermally insulating barrier 1, a primary thermally insulating barrier 4 resting on the secondary sealed membrane 3 and a primary sealed membrane 5, borne by the primary thermally insulating barrier 4 and intended to be in contact with the cryogenic fluid contained in the tank.

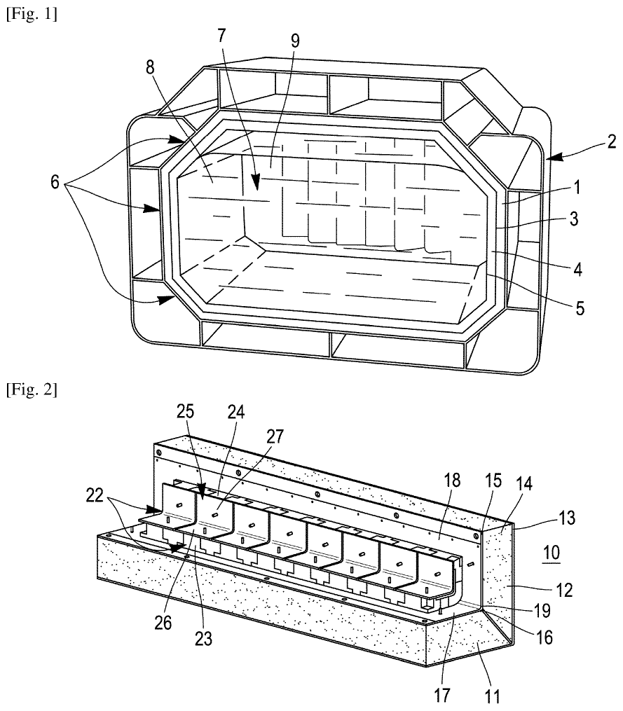

The bearing structure 2 can notably be a self-supporting metal sheet or, more generally, any type of rigid partition exhibiting appropriate mechanical properties. The bearing structure 2 can notably be formed by the hull or the double-hull of a ship as illustrated in [FIG. 1]. The bearing structure 2 comprises a plurality of walls defining the general form of the tank, usually a polyhedral form. Some tanks can also comprise only a single thermally insulating barrier and a single sealed membrane, for example for storing LPG.

As illustrated in [FIG. 1], the tank comprises lateral tank walls 6 and transverse tank walls 7 (a single transverse wall being illustrated in [FIG. 1]) which have a vertical component, that is to say a component parallel to the direction of the Earth's gravity. In such tank walls 6, 7 having a vertical component, the presence of channels running over the entire height of the walls 6, 7 is likely to promote natural convection phenomena. Indeed, in such walls 6, 7, thermosyphon phenomena can occur which leads to a degradation of the thermal insulation efficiencies of the thermally insulating barriers 1, 4. One aspect of the invention starts from the idea of limiting, even eliminating, these natural convection phenomena.

At the join between a first wall 8 of the tank, for example a lateral wall 6, and a second wall 9 of the tank, for example a transverse wall 7, the tank comprises a corner structure 10 illustrated in [FIG. 2]. This corner structure 10 is advantageously prefabricated.

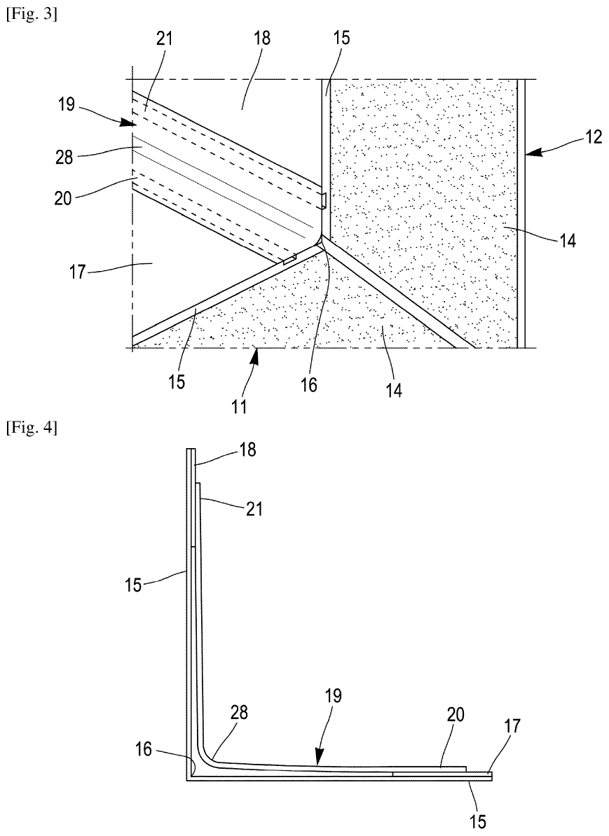

The corner structure 10 illustrated in [FIG. 2] comprises a first corner secondary insulating panel 11 and a second corner secondary insulating panel 12. The corner secondary insulating panels have, from the outside of the tank to the inside of the tank, an outer rigid plate 13, an insulating lining 14 and an inner rigid plate 15. The first corner secondary insulating panel 11 and the second corner secondary insulating panel 12 also have a beveled face, the beveled faces of said two corner secondary insulating panels 11, 12 being contiguous. Thus, as illustrated in [FIG. 3] in detail, the corner secondary insulating panels form an edge 16 of the secondary thermally insulating barrier 1.

The first corner secondary insulating panel 11 bears a first secondary sealed membrane portion 17 and the second corner secondary insulating panel 12 bears a second secondary sealed membrane portion 18. These first and second secondary sealed membrane portions 17, 18 can be produced in many ways. In one embodiment, the first and second secondary sealed membrane portions 17, 18 are made of laminated sealed film. Such a laminated sealed film comprises a metallic sheet, for example of aluminum, interposed between two resin-impregnated fiber layers. Such secondary sealed membrane portions 17, 18 made of laminated sealed film are for example glued to the inner face of the corner secondary insulating panels 11, 12. In another embodiment, the first and second secondary sealed membrane portions 17, 18 are metallic plates anchored to the corner secondary insulating panels 11, 12.

As illustrated in [FIG. 3], the secondary sealed membrane portions 17, 18 comprise a longitudinal edge running parallel to the edge 16 of the secondary thermally insulating barrier 1, said edge being arranged at a distance from the edge 16. Typically, the first secondary sealed membrane portion 17 forms an end of the secondary sealed membrane 3 of the first wall 8 and the second secondary sealed membrane portion 18 forms an end of the secondary sealed membrane 3 of the second wall 9.

In order to ensure the sealing of the secondary sealed membrane 3 in the corner of the tank, the corner structure 10 comprises a corner secondary sealed membrane portion 19. This corner secondary sealed membrane portion 19 tightly links the first secondary sealed membrane portion 17 and the second secondary sealed membrane portion 18. This corner secondary sealed membrane portion can be produced in many ways. In one embodiment, the corner secondary sealed membrane portion 19 is produced in a laminated sealed film, for example comprising a metallic sheet interposed between two non-resin-impregnated fiber layers. Such a corner secondary sealed membrane portion 19 made of laminated sealed film is for example glued to the first and second secondary sealed membrane portions 17, 18.

According to another embodiment, the corner secondary sealed membrane portion 19 is formed by a metal angle iron anchored tightly to the first and second secondary sealed membrane portions 17, 18.

As illustrated in detail in [FIG. 3], the corner secondary sealed membrane portion 19 runs along the edge 16. The corner secondary sealed membrane portion 19 has longitudinal edges parallel to the edge 16. A first longitudinal edge of the corner secondary sealed membrane portion 19 forms a first anchoring zone 20, illustrated by dotted lines in [FIG. 3], which is fixed tightly to the first secondary sealed membrane portion 17. Similarly, a second longitudinal edge of the corner secondary sealed membrane portion 19 forms a second anchoring zone 21, illustrated by dotted lines in [FIG. 3], which is fixed tightly to the second secondary sealed membrane portion 18.

The tight fixing of the anchoring zones 20, 21 of the corner secondary sealed membrane portion 19 to the secondary sealed membrane portions 17. 18 can be performed in many ways, for example by gluing in the context of a corner secondary sealed membrane portion 19 in the form of a laminated sealed film or even by welding in the context of a corner secondary sealed membrane portion 19 in the form of a metal angle iron. The inner rigid plate 15 of the corner secondary insulating panels 11, 12 can comprise a thermal protection strip housed in a countersink in order to protect said corner secondary insulating panels 11, 12 during such welding.

The corner structure 10 further comprises a plurality of primary insulating elements 22 juxtaposed along the edge 16 of the secondary thermally insulating barrier 1. Each primary insulating element 22 comprises a first primary insulating block 23 resting on the first secondary sealed membrane portion 17 and a second primary insulating block 24 resting on the second secondary sealed membrane portion 18. The plurality of primary insulating elements 22 forms the primary thermally insulating barrier 4.

The primary sealed membrane 5 comprises a plurality of metal corner angle irons 25 each resting on a respective primary insulating block 23, 24. Thus, each metal angle iron comprises a first wing 26 resting on the first primary insulating block 23 of a primary insulating element 22 and a second wing 27 resting on the second primary insulating block 24 of said primary insulating element 22.

The corner secondary sealed membrane portion 19 comprises a central zone 28 interposed between the first anchoring zone 20 and the second anchoring zone 21. This central zone 28 is arranged in line with the edge 16 and runs along the edge 16. This central zone 28 is not fixed to the secondary thermally insulating barrier 1. In other words, the central zone 28 is free with respect to the secondary thermally insulating barrier 1 and, more particularly, with respect to the edge 16. Other details and features of such a corner structure are described for example in the document WO2014167214A2.

The absence of fixing of the central zone 28 of the corner secondary sealed membrane portion 19 to the secondary thermally insulating barrier 1 makes it possible to absorb the strains undergone by the secondary sealed membrane 3 in line with the edge 16. Indeed, as illustrated in [FIG. 4], when the tank is constructed, the corner secondary sealed membrane portion 19 is arranged such that the central zone 28 is as close as possible to the edge 16. This arrangement makes it possible to limit the presence of empty space between the secondary sealed membrane 3 and the secondary thermally insulating barrier 1 promoting the convection.

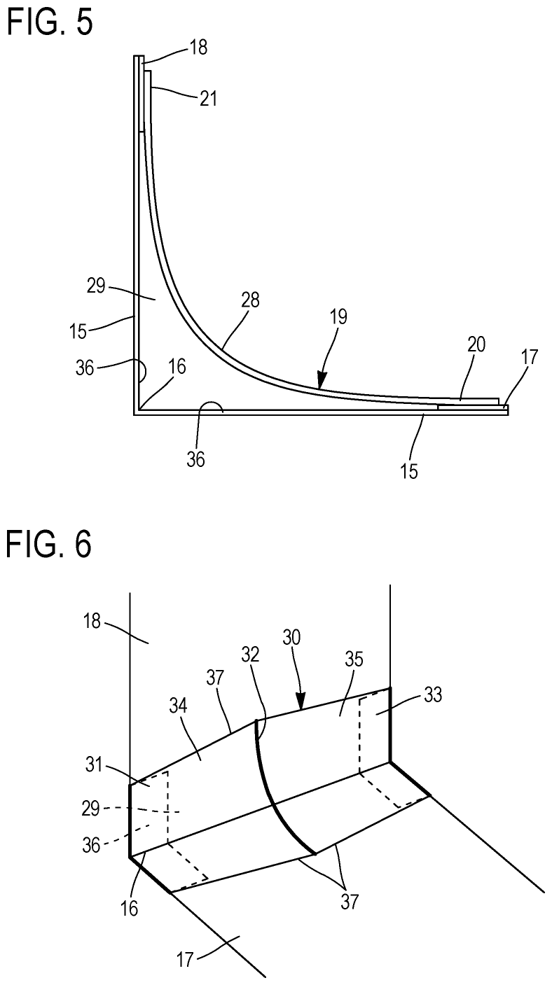

However, when the tank is cooled, the secondary sealed membrane 3, and therefore the corner secondary sealed membrane portion 19, contracts, which provokes a deformation by tightening of said corner secondary sealed membrane portion 19 as illustrated in [FIG. 5]. Similarly, the corner secondary insulating panels 11, 12 contract, which separates the anchoring zones 20, 21 of the corner secondary sealed membrane portion 19 from one another and therefore also provokes a deformation by tightening of said corner secondary sealed membrane portion 19.

As illustrated in [FIG. 5], the deformation by tightening of the corner secondary sealed membrane portion 19 separates the central zone 28 from the edge 16 which substantially increases the volume of the empty space between the corner secondary sealed membrane portion 19 and the secondary thermally insulating barrier 1 at the edge 16. Thus, a channel 29 appears or enlarges between the secondary sealed membrane 3 and the secondary thermally insulating barrier 1. This channel 29 runs over the entire length of the edge 16 and has a longitudinal direction parallel to the edge 16. Typically, this channel is delimited by an outer face of the central portion 28 of the corner secondary sealed membrane portion 19 and by a portion of the inner faces of the rigid plates 15 of the corner secondary insulating panels 11, 12 comprised between the edge 16 and the first and second secondary sealed membrane portions 17 and 18, said portion of the inner faces of the rigid plates 15 forming a bottom 36 of the channel 29.

To avoid the convection in the channel 29, the tank comprises a shutter 30. Such a shutter is arranged in the channel 29 between an inner face of the secondary thermally insulating barrier 1 and an outer face of the secondary sealed membrane 3.

[FIG. 6] illustrates an exemplary embodiment of such a shutter 30. This shutter 30 is produced in the form of a flexible film, for example having a polygonal form.

The shutter 30 can be produced using one of the materials cited hereinbelow or a composition formed by several of these materials: thermoplastic material comprising polyethylene (PE), polyethylene terephthalate (PET), polyamide, polyimide, polyetherimide, polypropylene in the form of a fabric film or not or any other material or fabric exhibiting a flexibility when cold. The shutter 30 can also be produced in woven fabric, possibly coated. The woven fabric can be produced based on different types of fibers, for example based on mineral fibers, such as glass fibers, basalt fibers or natural fibers for example based on hemp, linen or wool or thermoplastic fibers (PE, PET, PP, PI, PEI, etc.).

The flexible film 30 illustrated in [FIG. 6] comprises a first fixing zone 31, a second fixing zone 32 and a third fixing zone 33. The first fixing zone 31 and the third fixing zone 33 are formed at two opposite ends of the flexible film 30. These first and third fixing zones 31, 33 are, for example, formed by opposite transverse edges of the flexible film 30.

The second fixing zone 32 is interposed between the first fixing zone 31 and the third fixing zone 33, for example at a distance substantially equal to the first and third fixing zones 31 and 33.

The flexible film 30 also comprises a first shutting portion 34 interposed between the first fixing zone 31 and the second fixing zone 32 and a second shutting portion 35 interposed between the second fixing zone 32 and the third fixing zone 33.

The first fixing zone 31 and the third fixing zone 33 are fixed to the secondary thermally insulating barrier 1. More particularly, the first fixing zone 31 and the third zone 33 are fixed to the bottom 36 of the channel 29 so as to extend transversely, preferably at right angles, to the longitudinal direction of the channel 29.

This fixing of the first and third fixing zones 31 and 33 to the bottom 36 of the channel 29 can be performed in many ways. This fixing is, for example, produced by gluing or by means of a double-sided adhesive strip, for example comprising polytetrafluoroethylene (PTFE), interposed between each of said first and third fixing zones 31 and 33 and the bottom 36 of the channel 29.

The second fixing zone 32 is fixed to the outer face of the central portion 28 of the corner secondary sealed membrane portion 19. In a way similar to the fixing of the first and third fixing zones 31 and 33, the fixing of the second fixing zone 32 can be performed in many ways, for example by gluing or by means of a double-sided adhesive strip interposed between the second fixing zone 32 and the outer face of the central zone 28 of the corner secondary sealed membrane portion 19.

According to one embodiment, the installation of the flexible film 30 in the tank comprises, initially, fixing, by gluing or by means of an adhesive strip, the first and third fixing zones 31 and 33 to the bottom 36 of the channel 29. Moreover, a double-sided adhesive strip is applied to the outer face of the central portion 28 of the corner secondary sealed membrane portion 19 at the point where the second fixing zone 32 must be fixed. The corner secondary sealed membrane portion 19, provided with said double-sided adhesive strip, is, secondly, anchored to the first and second secondary sealed membrane portions 17 and 18. The anchoring of the corner secondary sealed membrane portion to said secondary sealed membrane portions 17 and 18 brings the double-sided adhesive strip against the second fixing zone 32 and thus fixes said second fixing zone 32 to the corner secondary sealed membrane portion 19. In the context of a corner secondary sealed membrane portion made of laminated sealed film, a pressure exerted on an inner face of said laminated sealed film in line with the double-sided adhesive strip can enhance the fixing of the second fixing zone 32 to said laminated sealed film.

The first shutting portion 34 and the second shutting portion 35 are free with respect to the secondary thermally insulating barrier 1 and to the secondary sealed membrane 3. In other words, said first and second shutting portions 34 and 35 are fixed neither to the secondary thermally insulating barrier 1 nor to the secondary sealed membrane 3. Thus, longitudinal edges 37 of the shutting portions 34 and 35 are loose and allow, on the one hand, a reduced circulation of gas in the channel 29, that is to say with a head loss linked to the arrangement of said shutting portions 34 and 35 in the channel 29, and, on the other hand, the deformation of the flexible film 30 to accompany the deformation by tightening of the corner secondary sealed membrane portion 19.

Indeed, as explained above and in light of the figures, when the tank is cooled, the corner secondary sealed membrane portion 19 tightens. Upon this tightening of the corner secondary sealed membrane portion 19, the second fixing zone 32 of the flexible film 30 fixed to the central zone 28 of the corner secondary sealed membrane portion 19 accompanies the variation of position of said central zone 28 linked to the deformation of the corner secondary sealed membrane portion 19. Since the first and third fixing zones 31 and 33 of the flexible film 30 are fixed to the secondary thermally insulating barrier 1, the shutting portions 34 and 35 of the flexible film 30 are tightened between said fixing zones 31, 32 and 33 and run in the channel 29 between the secondary thermally insulating barrier 1 and the secondary sealed membrane 3. Thus, the channel 29 is shut by the first shutting portion 34 and the second shutting portion 35 between the central zone 28 of the corner secondary sealed membrane portion 19 and the secondary thermally insulating barrier 1 while allowing a circulation of gas with head loss in the flow.

The accompanying of the variation of position of the corner secondary sealed membrane portion 19 by the second fixing zone 32 is facilitated when the flexible film 30 has good flexibility when cold. Thus, as represented in [FIG. 6], when the tank is cooled, the shutting portions 34 and 35 can deform slightly and take on a conical form.

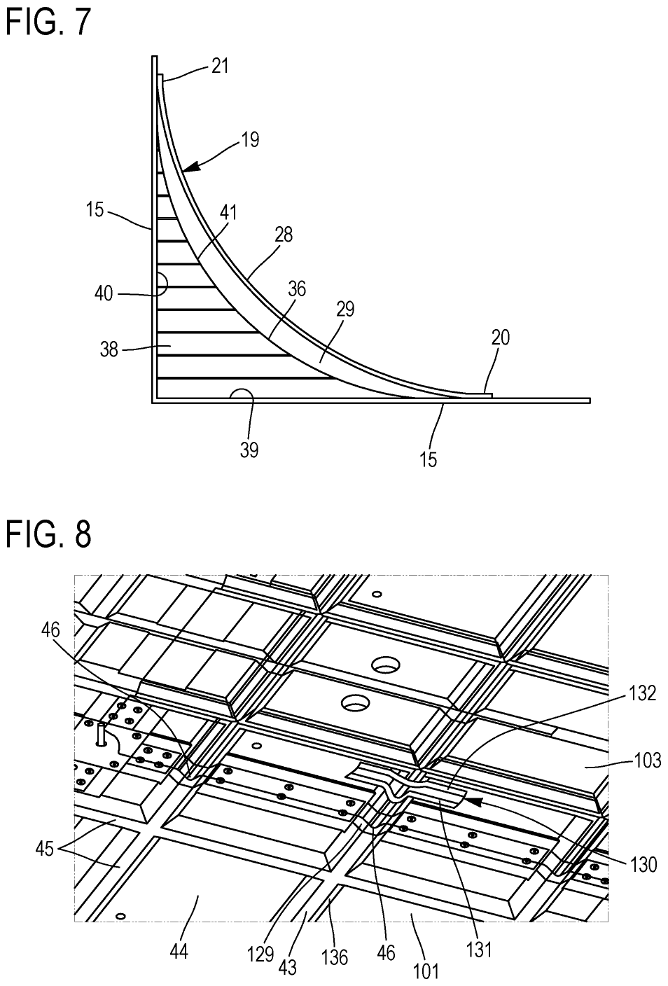

Such shutters 30 are advantageously arranged in the tank at corners of the tank whose edge 16 has a component parallel to the Earth's gravity, typically between the lateral walls 6 and the transverse walls 7 of the tank. Such shutters 30 can also be arranged in a tank at corners of the tank whose edge 16 is at right angles to the Earth's gravity. Furthermore, a plurality of shutters 30 can be arranged, for example at regular intervals, along the channel 29, thus controlling the head loss all along the channel 29.

[FIG. 7] illustrates an embodiment in which the corner secondary sealed membrane portion 19 is formed by a laminated sealed film glued to the first and second secondary sealed membrane portions 17 and 18 and in which the tank further comprises a positioning filler block 38 for the corner secondary sealed membrane portion 19.

Such a filler block 38 is arranged on the bottom 36 of the channel 29 along the edge 16 and has a first face 39 resting on the inner rigid plate 15 of a corner secondary insulating panel and a second face 40 resting on the inner rigid plate 15 of a corner secondary insulating panel. This filler block 38 further comprises an inner face 41 linking the first and second faces 39 and 40 of the filler block 38. This inner face 41 has a concave form whose concavity is turned toward the inside of the tank.

When installing the corner secondary sealed membrane portion 19, the central zone 28 of said corner secondary sealed membrane portion 19 is arranged so as to rest on the inner face 41 of the filler block 38. Thus, the corner secondary sealed membrane portion 19 is easily positioned for the gluing of the first and second fixing zones 20 and 21 respectively to the first and second secondary sealed membrane portions 17 and 18.

Such a filler block 38 thus makes it possible to control the radius of curvature of the central zone 28 of the corner secondary sealed membrane portion 19 when gluing said corner secondary sealed membrane portion 19, typically when manufacturing the tank.

Such a filler block 38 also makes it possible to reduce the dimensions of the channel 29, but cannot prevent the enlargement of said channel 29 during the cooling of the tank, as illustrated by the corner secondary sealed membrane portion 19 illustrated in this [FIG. 7] represented in a state of tension linked to the thermal contraction, as explained above. In such a channel 29, the inner face 41 then forms the bottom 36 of said channel 29.

With such a filler block 38 present, the first fixing zone 31 and the third fixing zone 33 of the shutter 30 can be fixed directly to the inner face 41 of the filler block 38.

In one embodiment, a first end of one or more of the fixing zones 31, 32 and/or 33 of the flexible film 30 is interposed between the first sealed membrane portion 17 and the first anchoring zone 20 of the corner secondary sealed membrane portion 19. Similarly, a second end of one or more fixing zones 31, 32 and/or 33 are interposed between the second secondary sealed membrane portion 18 and the second anchoring zone 21 of the corner secondary sealed membrane portion 19. Typically, these ends of said fixing zones 31. 32 and/or 33 are thus pinched between the first and second secondary sealed membrane portions 17 or 18 and the corner secondary sealed membrane portion 19, thus ensuring the fixing of the fixing zones 31, 32 and/or 33 in a simple manner.

[FIG. 8] illustrates a portion of secondary thermally insulating barrier 1 on which rests a corrugated secondary sealed membrane with outgoing corrugations, said secondary sealed membrane 3 being illustrated by transparency. In this figure, the elements that are identical or fulfil the same function as elements described above with respect to [FIGS. 1 to 7] bear the same reference increased by 100.

The secondary thermally insulating barrier 101 of a tank wall comprises a plurality of secondary insulating panels of parallelepipedal form which are juxtaposed according to a regular meshing. In a way similar to the first and second panels 11, 12 described above, these secondary insulating panels comprise an outer rigid plate (not illustrated), an insulating lining 43 and an inner rigid plate 44.

Moreover, an inner face of said insulating panels comprises a plurality of grooves 45 formed in the inner rigid plate 44, and possibly on the inner face of the insulating lining 43. These grooves 45 make it possible to house corrugations 46 of the secondary sealed membrane 103, a portion of which is represented by dotted lines in [FIG. 8].

However, the grooves 45 are dimensioned so as to manage the manufacturing and positioning tolerances of the secondary insulating panels and of the corrugations 46 of the secondary sealed membrane 103. In other words, there is, in said grooves 45, a space between the corrugations 46 and the secondary thermally insulating barrier 101 formed by the secondary insulating panels when the corrugations 46 are housed in the grooves 45. In a way similar to the corner of the tank between two tank walls described above, such spaces between the corrugations 46 and the secondary thermally insulating barrier 101 are likely to generate thermosyphon phenomena degrading the insulating efficiencies of the secondary thermally insulating barrier 101.

In order to avoid the thermosyphon phenomena in the grooves 45, a shutter 130 can also be placed between the secondary sealed membrane 103 and the secondary thermally insulating barrier 101 in the grooves 45 of the secondary thermally insulating barrier 101. Such a shutter 130 differs from the shutter 30 described above in light of [FIG. 6] in that it comprises only a first fixing zone 131 and a second fixing zone 132. The first fixing zone 131 is fixed to a bottom 136 of the channel 129 formed by the groove 45 of the secondary thermally insulating barrier 101. The second fixing zone 132 is fixed to an outer face of the secondary sealed membrane 103 and adheres to the outer face of the corrugation 46 and flat zones bordering said corrugation 46 and arranged in line with the groove 45.

Preferentially, the first and second fixing zones 131 and 132 run along a direction at right angles to the direction of the groove 45 over a distance greater than the width of the groove 45 taken in said direction at right angles to the longitudinal direction of the groove 45. In other words, in a way similar to the description given above, the first and second ends of the first and second fixing zones 131 and 132 are interposed between the flat portions of the secondary sealed membrane 103 and the inner face of the rigid plate 44 on which rests said flat faces of the secondary sealed membrane 103. Thus, the first fixing zone 131 and the second fixing zone 132 are fixed simply between the secondary sealed membrane 103 and the secondary thermally insulating barrier 101.

In an embodiment that is not illustrated, the shutter 130 is arranged in the channel 129 at the periphery of the inner face of an insulating panel forming the secondary thermally insulating barrier 1. Thus, when the shutter 130 is initially fixed to the bottom 136 of the channel 129, the application of the secondary fixing zone 132 to the inner face of the secondary sealed membrane 103 is facilitated by the simple access to the shutter via the groove 45 from the edge of the secondary insulating panel. In a variant of this embodiment, the lateral face of the secondary insulating panel and the bottom 136 of the channel at said lateral face are glued prior to the positioning of the sealed membrane and of the shutter 130. The second fixing zone 132 of the shutter 130 is, initially, fixed to the outer face of the secondary sealed membrane 103. Secondly, the secondary sealed membrane 103 is added to the secondary insulating panel such that the flexible film forming the shutter 130 extend beyond the lateral face of the secondary insulating panel. Thus, said overlapping portion of the film can easily be applied to the lateral face of the secondary insulating panel and to the bottom 136 of the channel 129 in order to fix the first fixing zone 131 to the secondary insulating panel.

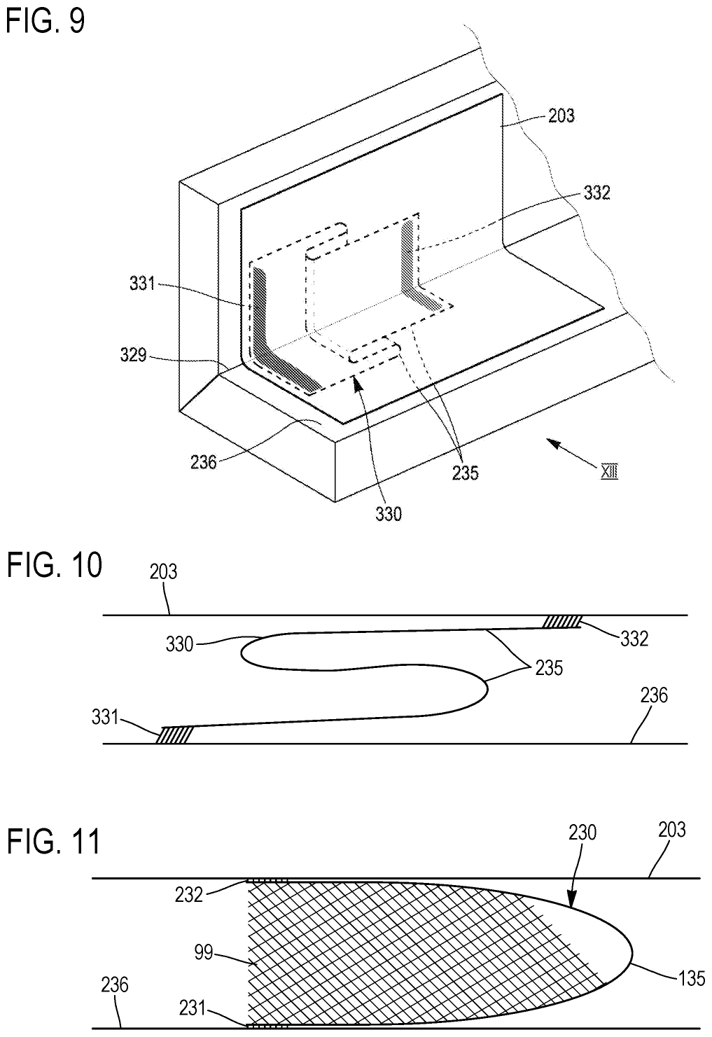

In an embodiment illustrated in [FIGS. 9 and 10], the shutter 330 comprises a first fixing zone 331 and a second fixing zone 332. The first fixing zone 331 and the second fixing zone 332 are formed at two opposite ends of the flexible film. The first fixing zone 331 is fixed to a bottom 236 of the channel 329. The second fixing zone 332 is fixed to an outer face of the sealed membrane 203. The first fixing zone 331 and the second fixing zone 332 are offset in the longitudinal direction of the channel 329. In other words, the first fixing zone and the second fixing zone are not facing one another such that the shutting portion 235 runs with a component parallel to the longitudinal direction of the channel 329. The shutting portion 235 comprises two folds substantially of a half turn spaced apart from one another and thus has a form resembling a Z.

In order to facilitate the incorporation of the shutter in the tank, the shutter 330 can be installed by prefabrication in the corner structure 10 before the placement of the corner structure 10 in the sealed and thermally insulating tank. The structure of the shutter 330 is simpler to put in place when the panels with a portion of the sealed membrane covering them are prefabricated in the factory.

In an embodiment illustrated in [FIG. 11], the shutter 230 is thus produced in the form of a flexible film which is folded about an axis transverse to the longitudinal direction of the channel, substantially in the form of a U. The shutter 230 comprises a first fixing zone 231, a second fixing zone 232 and a shutting portion 135 folded on itself. The first fixing zone 231 and the second fixing zone 232 are formed at two opposite ends of the flexible film. The first fixing zone 231 is fixed to a bottom 236 of the channel. The second fixing zone 232 is fixed to an outer face of the sealed membrane 203. The first fixing zone 231 and the second fixing zone 232 are facing one another. The flexible film has a length, when the shutting portion is arranged in a plane, greater than the distance between a fixing surface of the first fixing zone 231 to the bottom of the channel 229 and a fixing surface of the second fixing zone 232 to the sealed membrane.

The flexible film forms a fold in which, according to one embodiment, is housed a compressible element 99, for example produced in cotton, felt, glass wool, rock wool, or polymer foam. The compressible element 99 is compressed between the first and second fixing zones 231, 232 and thus exerts a reaction force which facilitates the glued fixing of the first fixing zone 231 and of the second fixing zone 232 respectively to the bottom of the channel and to the outer face of the sealed membrane. The shutter 230 is inserted into the sealed and thermally insulating tank in the gap between the bottom of the channel 229 and the sealed membrane.

According to one embodiment, an anti-adhesive film (not represented) which makes it possible to avoid the two parts of the flexible film folded with respect to one another from being glued together is inserted into the fold of the flexible film, in place of or in combination with the compressible element 99.

For the installation of the shutter 230 in the channel 229, a tool in the form of a blade can be used, if applicable a curved blade whose curvature corresponds to the form of the bottom of the channel, for example the curvature of the filler block 38 ([FIG. 7]). The anti-adhesive film and the flexible film are folded successively around the end edge of the blade in order to push them into the channel 29 or 229, for example between the filler block 38 and the corner secondary sealed membrane portion 19.

According to another embodiment, it is possible to use a dedicated tool to put the shutter in place. The tool comprises at least one blade which is intended to be inserted between the two folds of the shutting portion and a handle which allows manipulation of the tool. Note that the structure of the shutter 230, illustrated in [FIG. 11], is advantageous in that it lends itself more particularly to an in-situ installation of the shutter inside the tank once the latter is assembled, whereas the shutters described previously are simpler to put in place when the panels with a portion of the sealed membrane covering them are prefabricated in the factory.

The technique described above for producing a sealed and thermally insulating tank can be used in different types of containers, for example to limit the presence of continuous circulation channels in the thermally insulating barriers of a container of LNG in an onshore installation or in a floating structure such as a methane tanker ship or the like.

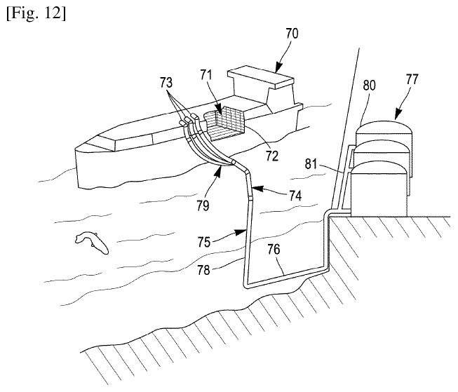

Referring to [FIG. 12], a cutaway view of a methane tanker ship 70 shows a sealed and insulated tank 71 of generally prismatic form mounted in the double-hull 72 of the ship. The wall of the tank 71 comprises a primary sealed barrier intended to be in contact with the LNG contained in the tank, a secondary sealed barrier arranged between the primary sealed barrier and the double-hull 72 of the ship, and two insulating barriers arranged respectively between the primary sealed barrier and the secondary sealed barrier and between the secondary sealed barrier and the double-hull 72.

As is known per se, loading/offloading pipelines 73 disposed on the top deck of the ship can be connected, by means of appropriate connectors, to a maritime or port terminal to transfer a cargo of LNG from or to the tank 71.

[FIG. 12] represents an example of maritime terminal comprising a loading and offloading station 75, a submarine line 76 and an onshore installation 77. The loading and offloading station 75 is a fixed offshore installation comprising a movable arm 74 and a riser 78 which supports the movable arm 74. The movable arm 74 bears a bundle of insulated flexible pipes 79 that can be connected to the loading/offloading pipelines 73. The orientable movable arm 74 adapts to all methane tanker templates. A link line not represented extends inside the riser 78. The loading and offloading station 75 allows the loading and the offloading of the methane tanker 70 from or to the onshore installation 77. The latter comprises liquefied gas storage tanks 80 and link lines 81 linked by the submarine line 76 to the loading or offloading station 75. The submarine line 76 allows the liquefied gas to be transferred between the loading or offloading station 75 and the onshore installation 77 over a great distance, for example 5 km, which makes it possible to keep the methane tanker ship 70 at a great distance from the coast during the loading and offloading operations.

To create the pressure necessary to the transfer of the liquefied gas, pumps embedded in the ship 70 and/or pumps with which the onshore installation 77 is equipped and/or pumps with which the loading and offloading station 75 is equipped are implemented.

Although the invention has been described in relation to several particular embodiments, it is quite clear that it is in no way limited thereto and that it encompasses all the technical equivalents of the means described and the combinations thereof provided the latter fall within the context of the invention as defined by the claims.

In particular, the above description in light of the figures is given in the context of a secondary thermally insulating barrier on which rests a secondary sealed membrane, but this description could be applied likewise to a channel running between a primary thermally insulating barrier and a primary sealed membrane or even in the context of a tank comprising only a single thermally insulating barrier and a single sealed membrane. Similarly, a shutter as described above could be arranged in a channel formed by the internal space of the corrugations of a sealed membrane. For example, such shutters could be arranged under corrugations of a secondary sealed membrane protruding toward the inside of the tank. Thus, such a shutter can be arranged in any channel likely to generate thermosyphon convection phenomena in a sealed and thermally insulating tank.

Likewise, the embodiment illustrated in the figures at represents a shutter comprising one or two fixing zones cooperating with the thermally insulating barrier and a fixing zone cooperating with the secondary sealed membrane, but the number of fixing zones able to cooperate with the sealed membrane and the number of fixing zones able to cooperate with the thermally insulating barrier can be different. A shutter can thus comprise a plurality of fixing zones intended to cooperate with the thermally insulating barrier alternately with a plurality of fixing zones intended to cooperate with the sealed membrane such that the shutting portions between a fixing zone on the thermally insulating barrier and a fixing zone on the sealed membrane runs in the channel to block said channel.

The use of the verb “comprise” or “include” and its conjugate forms does not preclude the presence of elements or steps other than those stated in a claim.

In the claims, any reference sign between parentheses should not be interpreted as a limitation of the claim.

1. A sealed and thermally insulating tank for storing fluid, said tank comprising a thermally insulating barrier (1, 4) and a sealed membrane (3, 5), the tank comprising a channel (29, 129, 229, 329) running along a longitudinal direction, said channel (29, 129, 229, 329) extending along the sealed membrane (3, 5) and being delimited, on the one hand, by the thermally insulating barrier (1, 4) and, on the other hand, by an outer face of the sealed membrane (3, 5), the thermally insulating barrier (1, 4) forming a bottom (36, 136, 236) of the channel (29, 129, 229, 329),
the tank further comprising a shutter (30, 130, 230, 330) arranged in the channel (29, 129, 229, 329), said shutter (30, 130, 230, 330) comprising a flexible film, said flexible film comprising a first fixing zone (31, 131, 231, 331) and a second fixing zone (32, 132, 232, 332),
the first fixing zone (31, 131, 231, 331) extending transversely to the longitudinal direction of the channel (29, 129, 229, 329), the first fixing zone (31, 131, 231, 331) of said flexible film being fixed to the bottom (36, 136, 236) of the channel (29, 129, 229, 329),
the second fixing zone (32, 132, 232, 332) extending transversely to the longitudinal direction of the channel (29, 129, 229, 329), the second fixing zone (32, 132, 232, 332) being fixed to the outer face of the sealed membrane (3, 5) delimiting the channel (29, 129, 229, 329),
the flexible film comprising a shutting portion (34, 35, 135, 235) extending from the first fixing zone (31, 131, 231, 331) to the second fixing zone (32, 132, 232, 332), said shutting portion (34, 35, 135) extending across the channel (29, 129, 229, 329) between the bottom (36, 136, 236) of the channel (29, 129, 229, 329) and the sealed membrane (3, 5) so as to create a head loss in the channel.

2. The sealed and thermally insulating tank for storing fluid as claimed in claim 1, wherein the shutting portion of the flexible film is a first shutting portion (34), the flexible film comprises a third fixing zone (33) extending transversely to the longitudinal direction of the channel (29, 129, 229, 329), the third fixing zone (33) being fixed to the bottom (36) of the channel (29, 129, 229, 329), the second fixing zone (32) being interposed between the first fixing zone (31) and the third fixing zone (33), the flexible film comprising a second shutting portion (35) extending from the second fixing zone (32) to the third fixing zone (33), said second shutting portion (35) extending across the channel (29, 129, 229, 329) between the bottom (36) of the channel (29) and the sealed membrane (3, 5) so as to create a head loss in the channel (29, 129, 229, 329).

3. The sealed and thermally insulating tank as claimed in claim 1, wherein the shutting portion is deformable and comprises at least one fold along an axis transverse to the longitudinal direction of the channel (29, 129, 229, 329).

4. The sealed and thermally insulating tank as claimed in claim 3, wherein the first fixing zone and the second fixing zone are situated at two opposite ends of the flexible film and are disposed at a same level in the longitudinal direction of the channel (29, 129, 229, 329).

5. The sealed and thermally insulating tank as claimed in claim 3, wherein the shutting portion comprises two folds mutually spaced apart in the longitudinal direction of the channel (29, 129, 229, 329), each fold being produced along an axis transverse to the longitudinal direction of the channel (29, 129, 229, 329), the first fixing zone and the second fixing zone being situated at two opposite ends of the flexible film and offset in the longitudinal direction of the channel.

6. The sealed and thermally insulating tank as claimed in claim 1, wherein the flexible film is made of material chosen from the group consisting of a glass mat, a polyethylene film and/or a polyamide film.

7. The sealed and thermally insulating tank as claimed in claim 1, wherein the first fixing zone (31, 131, 231, 331) and/or the second fixing zone (32, 132, 232, 332) extend in a plane secant to the longitudinal direction of the channel (29, 129, 229, 329).

8. The sealed and thermally insulating tank as claimed in claim 1, the tank comprising a plurality of shutters (30, 130, 230, 330) arranged in the channel (29) along the longitudinal direction of the channel (29, 129, 229, 329).

9. The sealed and thermally insulating tank as claimed in claim 8, wherein the shutters (30, 130, 230, 330) of the plurality of shutters (30, 130, 230, 330) are arranged in the channel (29, 129, 229, 329) at regular intervals along the longitudinal direction of the channel (29, 129, 229, 329).

10. The sealed and thermally insulating tank as claimed in claim 8, wherein the thermally insulating barrier forming the bottom of the channel comprises a plurality of insulating panels spaced apart and a plurality of junction zones situated between the insulating panels, and the shutters are arranged facing the insulating panels in such a way that the junction zones at each end of a panel are located between the shutters.

11. The sealed and thermally insulating tank as claimed in claim 1, comprising a first tank wall (8) and a second tank wall (9), the first tank wall (8) and the second tank wall (9) forming an edge (16) of the thermally insulating barrier (1), the first tank wall (8) comprising a first anchoring surface and the second tank wall (9) forming a second anchoring surface, the bottom (36) of the channel (29) being formed by the thermally insulating barrier (1) between the first anchoring surface and the second anchoring surface, the bottom of the channel (29) forming the edge (16), and wherein the sealed membrane (3) comprises a corner sealed part (19), the corner sealed part (19) comprising a first portion (20) anchored to the first anchoring surface and a second portion (21) anchored to the second anchoring surface, the corner sealed part (19) further comprising a central portion (28) interposed between the first portion (20) and the second portion (21), said central portion (28) being free with respect to the thermally insulating barrier (1) so as to absorb by deformation the strains in the sealed membrane (3) in line with the edge (16), the channel being delimited by the outer face of the corner sealed part (19).

12. The sealed and thermally insulating tank as claimed in claim 11, comprising a corner structure (10), said corner structure (10) comprising a first insulating panel (11) and a second insulating panel (12), the first insulating panel (11) forming an end of the thermally insulating barrier (1) of the first tank wall (8), the second insulating panel (12) forming an end of the thermally insulating barrier (1) of the second tank wall (9), the first insulating panel (11) and the second insulating panel (12) jointly forming the edge (16),
the corner structure (10) further comprising a first sealed membrane portion (17) and a second sealed membrane portion (18), the first sealed membrane portion (17) resting on the first insulating panel (11), said first sealed membrane portion (17) forming an end of the sealed membrane (3) of the first tank wall (8), the second sealed membrane portion (18) resting on the second insulating panel (12), said second sealed membrane portion (18) forming an end of the sealed membrane (3) of the second tank wall (9).

13. The sealed and thermally insulating tank as claimed in claim 1, further comprising a filler block (38), said filler block (38) comprising a first outer face resting against the thermally insulating barrier (1) of the first tank wall (8) and a second outer face resting against the thermally insulating barrier (1) of the second tank wall (9), the filler block (38) further comprising a concave inner face (41), the channel (29) being delimited by the inner face (41) of the filler block (38).

14. The sealed and thermally insulating tank as claimed in claim 1, wherein the sealed membrane (103) comprises a corrugation (46), said corrugation (46) protruding toward the thermally insulating barrier (101), said corrugation (46) running in the longitudinal direction of the channel (129), the thermally insulating barrier (101) comprising a groove (45), said corrugation (46) being housed in said groove (45), the bottom (136) of the channel (129) being formed by said groove (45).

15. The sealed and thermally insulating tank as claimed in claim 1, wherein the sealed membrane (103) comprises a series of parallel corrugations (46) and flat portions, said flat portions being situated between two adjacent parallel corrugations (46), said parallel corrugations (46) protruding toward the thermally insulating barrier (101), the thermally insulating barrier (101) comprising a series of parallel grooves (45), the parallel corrugations (46) being housed in one said respective groove (45),
the tank further comprising a plurality of channels (129) delimited, on the one hand, by one said respective groove (45) and, on the other hand, by the sealed membrane (103), a bottom (136) of each channel (129) being formed by one said corresponding groove (45),
the tank further comprising a plurality of shutters (130), said shutters (130) comprising a flexible film, said flexible film comprising a first fixing zone (131) and a second fixing zone (132),
the first fixing zone (131) extending transversely to the longitudinal direction of the corresponding groove (45), the first fixing zone (131) of said flexible film being fixed to the bottom (136) of the corresponding channel (129),
the second fixing zone (132) extending transversely to the longitudinal direction of said channel (129), the second fixing zone (132) being fixed to the outer face of the sealed membrane (103) delimiting said channel (129),
said flexible film comprising a shutting portion extending from the first fixing zone (131) to the second fixing zone (132), said shutting portion extending across the channel (129) between the bottom (136) of said channel (129) and the sealed membrane (103) so as to create a head loss in said channel (129).

16. The sealed and thermally insulating tank as claimed in claim 1, wherein the channel (29, 129, 229, 329) has a component that is parallel or a component that is at right angles to the direction of the Earth's gravity.

17. A ship (70) for transporting a cold liquid product, the ship comprising a double-hull (72) and a tank (71) as claimed in claim 1 disposed in the double-hull.

18. A transfer system for a cold liquid product, the system comprising a ship (70) as claimed in claim 17, insulated pipelines (73, 79, 76, 81) arranged so as to link the tank (71) installed in the hull of the ship to a floating or onshore storage installation (77) and a pump for driving a flow of cold liquid product through the insulated pipelines from or to the floating or onshore storage installation to or from the tank of the ship.

19. A method for loading or offloading a ship (70) for transporting a cold liquid product, the ship comprising a double-hull (72) and a tank (71) disposed in the double-hull, said tank comprising a thermally insulating barrier (1, 4) and a sealed membrane (3, 5), the tank comprising a channel (29, 129, 229, 329) running along a longitudinal direction, said channel (29, 129, 229, 329) extending along the sealed membrane (3, 5) and being delimited, on the one hand, by the thermally insulating barrier (1, 4) and, on the other hand, by an outer face of the sealed membrane (3, 5), the thermally insulating barrier (1, 4) forming a bottom (36, 136, 236) of the channel (29, 129, 229, 329),
the tank further comprising a shutter (30, 130, 230, 330) arranged in the channel (29, 129, 229, 329), said shutter (30, 130, 230, 330) comprising a flexible film, said flexible film comprising a first fixing zone (31, 131, 231, 331) and a second fixing zone (32, 132, 232, 332),
the first fixing zone (31, 131, 231, 331) extending transversely to the longitudinal direction of the channel (29, 129, 229, 329), the first fixing zone (31, 131, 231, 331) of said flexible film being fixed to the bottom (36, 136, 236) of the channel (29, 129, 229, 329),
the second fixing zone (32, 132, 232, 332) extending transversely to the longitudinal direction of the channel (29, 129, 229, 329), the second fixing zone (32, 132, 232, 332) being fixed to the outer face of the sealed membrane (3, 5) delimiting the channel (29, 129, 229, 329),
the flexible film comprising a shutting portion (34, 35, 135, 235) extending from the first fixing zone (31, 131, 231, 331) to the second fixing zone (32, 132, 232, 332), said shutting portion (34, 35, 135) extending across the channel (29, 129, 229, 329) between the bottom (36, 136, 236) of the channel (29, 129, 229, 329) and the sealed membrane (3, 5) so as to create a head loss in the channel,
wherein a cold liquid product is conveyed through insulated pipelines (73, 79, 76, 81) from or to a floating or onshore storage installation (77) to or from the tank of the ship (71).
